(19) United States
(12) Patent Application Publication
(10) Pub. No.: US 2012/0126712 A1
(43) Pub. Date: May 24, 2012

(54) LIGHT EMITTING DIODE DRIVING CIRCUIT, AND DISPLAY DEVICE HAVING THE SAME

(76) Inventor: Yong-Hun KIM, Seoul (KR)

(21) Appl. No.: 13/240,616

(22) Filed: Sep. 22, 2011

(30) Foreign Application Priority Data
Nov. 23, 2010 (KR) 10-2010-0116934

(51) Int. Cl. H05B 37/02

(52) U.S. Cl. 315/187; 315/192

(57) ABSTRACT

Provided are an LED driving circuit capable of preventing distortion of LED currents and having a high operating speed, and a display device including the LED driving circuit. The LED driving circuit includes a current driving circuit, a dynamic headroom controller and a power supply circuit. The current driving circuit controls current signals flowing through LED strings in response to a first control signal that includes information of an LED current and a current-driving-circuit enabling signal. The dynamic headroom controller generates a dynamic headroom control signal having a voltage level that changes according to a logic state of the current-driving-circuit enabling signal. The power supply circuit generates an LED driving voltage that changes according to the dynamic headroom control signal.

### CROSS-REFERENCE TO RELATED APPLICATION

Korean Patent Application No. 10-2010-0116934, filed on Nov. 23, 2010, in the Korean Intellectual Property Office, and entitled: “Light Emitting Diode Driving Circuit, And Display Device Having the Same,” is incorporated by reference herein in its entirety.

### BACKGROUND

1. Field

Example embodiments relate to a light-emitting-diode (LED) driving circuit and a display device including the LED driving circuit.

2. Description of Related Art

Recently, research on various types of light emitting technology is in progress due to the market demand for eco-friendly and low-power products.

Display devices now in use include plasma-display panels (PDPs), liquid-crystal displays (LCDs), light-emitting-diode (LED) display devices, etc. The LED display device is a self-emitting device that emits light in response to a voltage applied between two terminals, and has attracted attention as next generation technology because of merits of stability, low heating value and low power consumption. LED display devices are used as lamp devices and back-light units of LCD devices.

### SUMMARY

One or more embodiments provide a light-emitting-diode (LED) driving circuit capable of preventing distortion of current flowing through LED strings and having a high switching speed.

One or more embodiments provide an LED system including the LED driving circuit.

One or more embodiments provide a display device including the LED driving circuit.

One or more embodiments provide a method of driving an LED capable of preventing distortion of current flowing through LED strings and having a high switching speed.

One or more embodiments may provide an LED driving circuit including a current driving circuit, a dynamic headroom controller, and a power supply circuit.

One or more embodiments may provide a light emitting-diode (LED) driving circuit, including a current driving circuit configured to control current signals flowing through LED strings in response to a first control signal that includes information of an LED current and a current-driving-circuit enabling signal, a dynamic headroom controller configured to generate a dynamic headroom control signal having a voltage level that changes according to a logic state of the current-driving-circuit enabling signal based on voltage signals of first terminals of each of the LED strings and the current-driving-circuit enabling signal, and a power supply circuit configured to generate an LED driving voltage that changes according to the dynamic headroom control signal, and provide the LED driving voltage to second terminals of each of the LED strings.

The dynamic headroom control signal may be configured to have a first voltage level when the current-driving-circuit enabling signal is enabled, and have a second voltage level higher than the first voltage level when the current-driving-circuit enabling signal is disabled.

The dynamic headroom controller may be configured to increase magnitudes of the voltage signals of the first terminals of each of the LED strings when the current-driving-circuit enabling signal is disabled, and maintain the magnitudes of the voltage signals of the first terminals of each of the LED strings higher than a first reference voltage corresponding to a voltage signal having a lowest voltage level among voltage signals of the first terminals of each of the LED strings when the current-driving-circuit enabling signal is enabled.

A current flowing through each of the LED strings may not be distorted when the current-driving-circuit enabling signal changes from a disable state to an enable state.

A current flowing through each of the LED strings may increase linearly and/or substantially linearly before reaching a constant and/or substantially constant level when the current-driving-circuit enabling signal changes from a disable state to an enable state.

The dynamic headroom controller may include a level detector configured to detect voltage levels of voltage signals of the first terminals of each of the LED strings, and generate a minimum detection voltage signal having a minimum voltage level of the detected voltage levels, a comparator configured to compare the minimum detection voltage signal with a first reference voltage to generate comparison output data, an adder configured to add first data to the comparison output data to generate added output data, a selecting circuit configured to select one of the comparison output data and the added output data in response to the current-driving-circuit enabling signal, and a digital-to-analog converter configured to perform digital-to-analog conversion with respect to an output signal of the selecting circuit to generate the dynamic headroom control signal.

The selecting circuit may be configured to output the comparison output data when the current-driving-circuit enabling signal is enabled, and output the added output data when the current-driving-circuit enabling signal is disabled.

The dynamic headroom controller may include a level detector configured to detect voltage levels of voltage signals of the first terminals of each of the LED strings, and generate a minimum detection voltage signal having a minimum voltage level of the detected voltage levels, a comparator configured to compare the minimum detection voltage signal with a first reference voltage to generate comparison output data, a compensating circuit configured to compensate a frequency characteristic of the comparison output data, an adder configured to add first data to output data of the compensating circuit to generate added output data, a selecting circuit configured to select one of the comparison output data and the added output data in response to the current-driving-circuit enabling signal, and a digital-to-analog converter configured to perform digital-to-analog conversion with respect to an output signal of the selecting circuit to generate the dynamic headroom control signal.

Wherein a voltage between a source and a drain of a power transistor included in the current driving circuit may change according to a change of current signals flowing through the LED strings.

The LED driving circuit may include an error amplifier configured to amplify a difference between a feedback voltage corresponding to the LED driving voltage and the dynamic headroom control signal to generate a first amplified signal, and provide the first amplified signal to the power supply circuit.

Each of the LED strings may include at least one LED serially connected to each other.

Second terminals of each of the LED strings may be electrically connected to each other.

The power supply circuit may be a DC-DC converter.

The power supply circuit may include an inductor, first, second, and third resistors, an NMOS power transistor, a diode, and a capacitor.

The current driving circuit may include a plurality of current drivers, each including an amplifier, a switch, an NMOS transistor, and a resistor.

In the current driving circuit, the switch may be configured to operate in response to the current-driving-circuit enabling signal, a first terminal to which the first control signal is applied and a second terminal coupled to a gate of the NMOS transistor.

One or more embodiments provide a method of driving a light-emitting diode (LED), the method including controlling current signals flowing through LED strings in response to a first control signal that includes information of an LED current and a current-driving-circuit enabling signal, sensing voltage signals of first terminals of each of the LED strings, generating a dynamic headroom control signal having a voltage level that changes according to a logic state of the current-driving-circuit enabling signal based on voltage signals of the first terminals of each of the LED strings and the current-driving-circuit enabling signal, generating an LED driving voltage that changes according to the dynamic headroom control signal, and providing the LED driving voltage to second terminals of each of the LED strings.

The dynamic headroom control signal may be configured to have a first voltage level when the current-driving-circuit enabling signal is enabled, and have a second voltage level higher than the first voltage level when the current-driving-circuit enabling signal is disabled.

Generating the dynamic headroom control signal may include detecting voltage levels of voltage signals of the first terminals of each of the LED strings, generating a minimum detection voltage signal having a minimum voltage level of the detected voltage levels, comparing the minimum detection voltage signal with a first reference voltage to generate comparison output data, adding first data to the comparison output data to generate added output data, selecting one of the comparison output data and the added output data in response to the current-driving-circuit enabling signal, and performing digital-to-analog conversion with respect to an output signal of the selecting circuit to generate the dynamic headroom control signal.

The method may further include compensating a frequency characteristic of the comparison output data.

One or more embodiments provide a light-emitting-diode (LED) driving circuit including an LED string, the circuit including a selecting circuit configured to output one of a first voltage and a second voltage that is different from the first voltage based on a logical state of a current-driving-circuit enabling signal, wherein the first or second voltage output from the selecting circuit is employed to generate a control signal to be supplied to the LED string.

### BRIEF DESCRIPTION OF THE DRAWINGS

Features will become more apparent to those of ordinary skill in the art by describing in detail exemplary embodiments with reference to the attached drawings, in which:

FIG. 1 illustrates a block diagram of an exemplary embodiment of a light-emitting-diode (LED) system;

FIG. 2 illustrates a block diagram of an exemplary embodiment of an LED driving circuit of the LED system of FIG. 1;

FIG. 3 illustrates a circuit diagram of an exemplary embodiment of a current driving circuit of the LED driving circuit of FIG. 2;

FIG. 4 illustrates a block diagram of another exemplary embodiment of an LED driving circuit of the LED system of FIG. 1;

FIG. 5 illustrates a block diagram of an exemplary embodiment of a circuit employable to generate a control signal (VCON1) in the LED system of FIG. 1;

FIG. 6 illustrates a graph of a relationship between a drain-source voltage and a drain current of a MOS transistor included in the current driving circuit in FIG. 3;

FIG. 7 illustrates a circuit diagram of an exemplary embodiment of a power supply circuit of the LED driving circuit of FIG. 2;

FIG. 8 illustrates a circuit diagram of an exemplary embodiment of a dynamic headroom controller of the LED driving circuit of FIG. 2;

FIG. 9 illustrates a circuit diagram of another exemplary embodiment of a dynamic headroom controller of the LED driving circuit of FIG. 2;

FIG. 10 illustrates a timing diagram of exemplary operations of the LED system of FIG. 1;

FIG. 11 illustrates a block diagram of another exemplary embodiment of an LED driving circuit of the LED system of FIG. 1;

FIG. 12 illustrates a block diagram of an exemplary embodiment of a back-light system including an LED driving circuit;

FIG. 13 illustrates a block diagram of another exemplary embodiment of a back-light system including an LED driving circuit;

FIG. 14 illustrates a block diagram another exemplary embodiment of a back-light system including an LED driving circuit;

FIG. 15 illustrates a flowchart of an exemplary embodiment of a method of driving an LED; and

FIG. 16 illustrates a flowchart of an exemplary embodiment of a method of generating a dynamic headroom control signal (VO_DHC) shown in FIG. 15.

### DETAILED DESCRIPTION

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

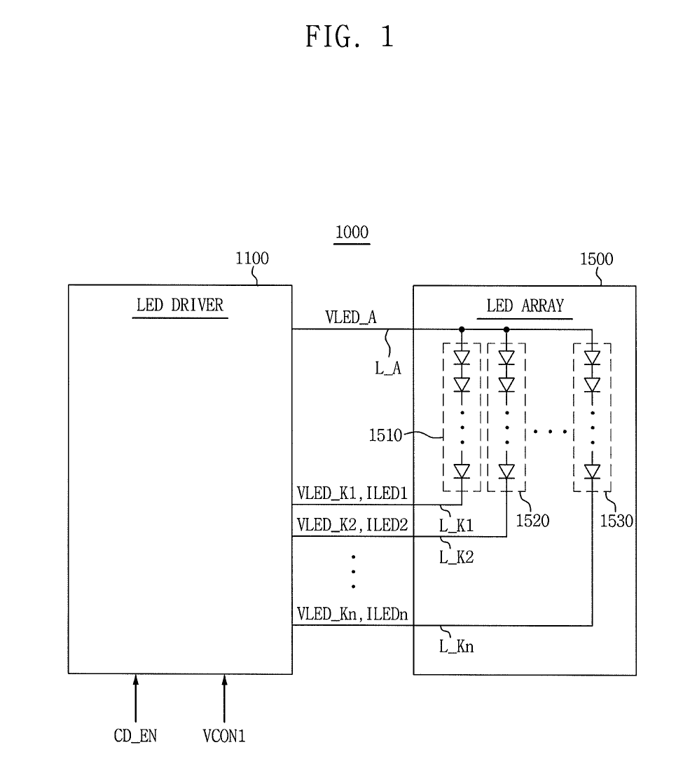

FIG. 1 illustrates a block diagram of an exemplary embodiment of a light-emitting-diode (LED) system 1000. Referring to FIG. 1, the LED system 1000 may include an LED driving circuit 1100 and an LED array 1500.

The LED array 1500 may emit light in response to an LED driving voltage VLED_A. The LED array 1500 may include one or more LED strings 1510, 1520, 1530. Each of the LED strings 1510, 1520 and 1530 may include one or more LEDs connected in series.

The LED driving circuit 1100 may generate a dynamic headroom control signal having a voltage level that changes according to a logic state of a current-driving-circuit enabling signal CD_EN. The LED driving circuit 1100 may generate the LED driving voltage VLED_A based on the dynamic headroom control signal. The LED driving circuit 1100 may control current signals flowing through the LED strings 1510, 1520, 1530 based on a first control signal VCON1. The first control signal VCON1 may include information regarding LED current and the current-driving-circuit enabling signal CD_EN. The information of the LED current may be a target LED current that may be controlled inside of a semiconductor integrated circuit including the LED driving circuit 1100 or outside of the semiconductor integrated circuit by a user.

First terminals L_K1, L_K2, . . . , L_Kn of the LED strings 1510, 1520, 1530 may be connected to drains of respective power transistors of a current driving circuit included in the LED driving circuit 1100. In FIG. 1, voltages of the first terminals L_K1, L_K2, . . . , L_Kn are denoted by VLED_K1, VLED_K2, . . . , VLED_Kn, and currents flowing from the respective first terminals L_K1, L_K2, . . . , L_Kn to drains of the respective power transistors included in the LED driving circuit 1100 are denoted by ILED1, ILED2, . . . , ILEDn. Referring to FIG. 1, second terminals L_A of the respective LED strings 1510, 1520, 1530 are electrically connected to each other.

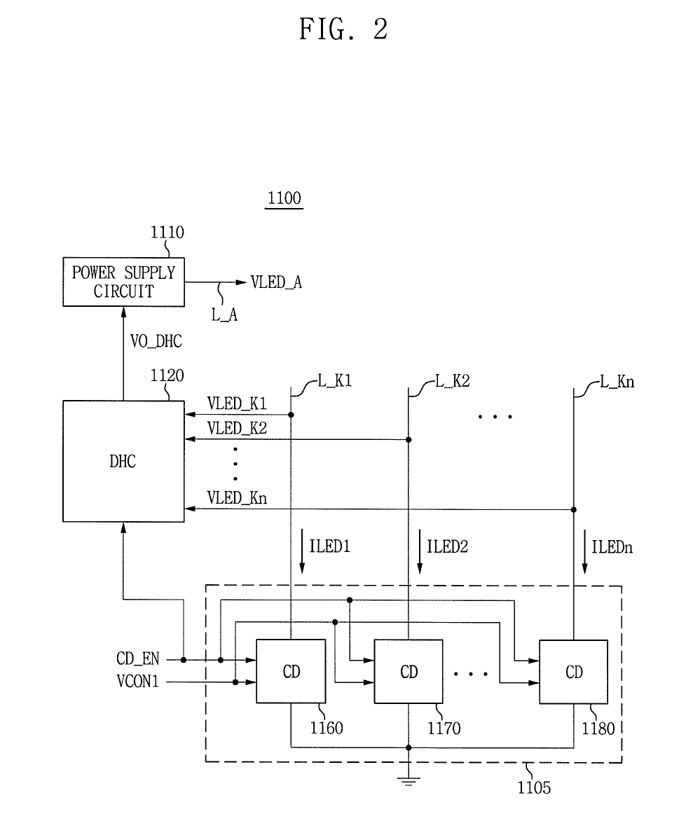

FIG. 2 illustrates a block diagram of an exemplary embodiment of the LED driving circuit 1100 employable in the LED system 1000 of FIG. 1.

Referring to FIG. 2, the LED driving circuit 1100 may include a power supply circuit 1110, a dynamic headroom controller 1120, and a current driving circuit 1105.

The current driving circuit 1105 may include current drivers 1160, 1170 and 1180. The current driving circuit 1105 may control current signals ILED1, ILED2, . . . , ILEDn flowing through LED strings 1510, 1520, 1530 in response to the current-driving-circuit enabling signal CD_EN and the first control signal VCON1 that includes information of an LED current. The first control signal VCON1 may be generated inside of a semiconductor integrated circuit including the LED driving circuit 1100 or outside of the semiconductor integrated circuit. The current-driving-circuit enabling signal CD_EN may be a pulse-width modulated signal.

The dynamic headroom controller 1120 may generate a dynamic headroom control signal VO_DHC having a voltage level that changes according to a logic state of the current-driving-circuit enabling signal CD_EN based on the voltage signals VLED_K1, VLED_K2, VLED_Kn of the first terminals L_K1, L_K2, L_Kn of each of the LED strings and the current-driving-circuit enabling signal CD_EN.

The power supply circuit 1110 may generate the LED driving voltage VLED_A that changes according to the dynamic headroom control signal VO_DHC. The power supply circuit may provide the LED driving voltage VLED_A to the second terminals L_A of each of the LED strings.

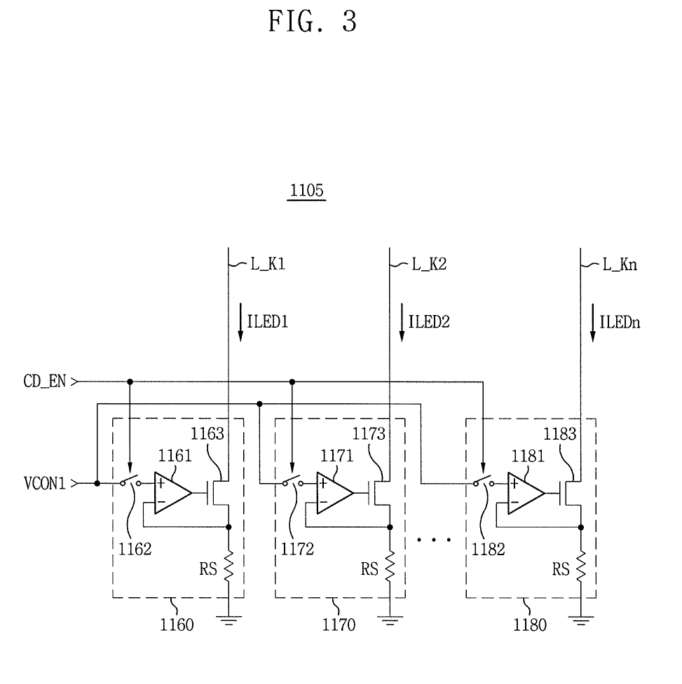

FIG. 3 illustrates a circuit diagram of an exemplary embodiment of the current driving circuit 1105 employable in the LED driving circuit 1100 of FIG. 2.

Referring to FIG. 3, the current driver 1160 may include an amplifier 1161, a switch 1162, an NMOS transistor 1163, and a resistor RS. The resistor RS has a first terminal connected to the ground. The NMOS transistor 1163 has a drain connected to a first terminal of the LED string 1510 in FIG. 1 and a source connected to a second terminal of the resistor RS. The switch 1162 has a first terminal to which the first control signal VCON1 is applied, and operates in response to the current-driving-circuit enabling signal CD_EN. The amplifier 1161 has a first input terminal connected to a second terminal of the switch 1162, a second input terminal connected to the source of the NMOS transistor 1163, and an output terminal connected to a gate of the NMOS transistor 1163.

The amplifier 1161 may be a differential amplifier, and may amplify a difference between the first control signal VCON1 that includes information of an LED current and a feedback signal. The resistor RS is coupled between the source of the NMOS transistor 1163 and the ground, and may determine a magnitude of a drain current of the NMOS transistor 1163.

As shown in FIG. 3, the current drivers 1170, 1180 may have the same circuit structure as the current driver 1160, and may operate in a similar way to the current driver 1160.

In FIG. 3, the switching transistors 1163, 1173m 1183 included in the current driving circuit 1105 may be arbitrary power transistors such as n-type lateral-diffused MOS transistors, power MOS field effect transistors (MOSFETs), insulated gate bipolar transistors (IGBTs), etc.

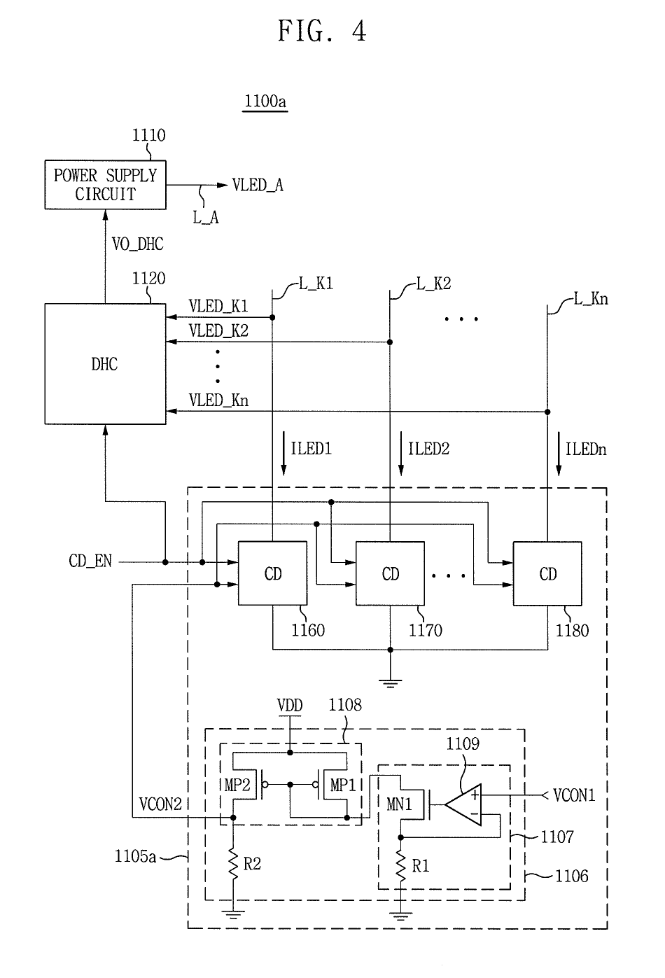

FIG. 4 illustrates a block diagram of another exemplary embodiment of an LED driving circuit 1100a employable in the LED system 1000 of FIG. 1. In general, only differences between the exemplary LED driving circuit 1100a of FIG. 4 and the exemplary LED driving circuit 1100 of FIG. 2 will be described below.

In the exemplary embodiment of FIG. 4, the LED driving circuit 1100a includes a current driving circuit 1105a. The current driving circuit 1105a may include the current drivers 1160, 1170, 1180, and an input circuit 1106. The input circuit 1106 may include a buffer circuit 1107, a current-mirror circuit 1108, and a resistor R2. The buffer circuit 1107 may include an amplifier 1109, an NMOS transistor MN1 and a resistor R1. The buffer circuit 1107 may stabilize the first control signal VCON1. The current-mirror circuit 1108 may include PMOS transistors MP1 and MP2. The current-mirror circuit 1108 may output a current having a magnitude proportional to a current flowing through the NMOS transistor MN1. The resistor R2 may generate a second control signal VCON2 that is a voltage signal corresponding to a current flowing through the PMOS transistor MP2. The current drivers 1160, 1170 and 1180 may operate in response to the current-driving-circuit enabling signal CD_EN and the second control signal VCON2.

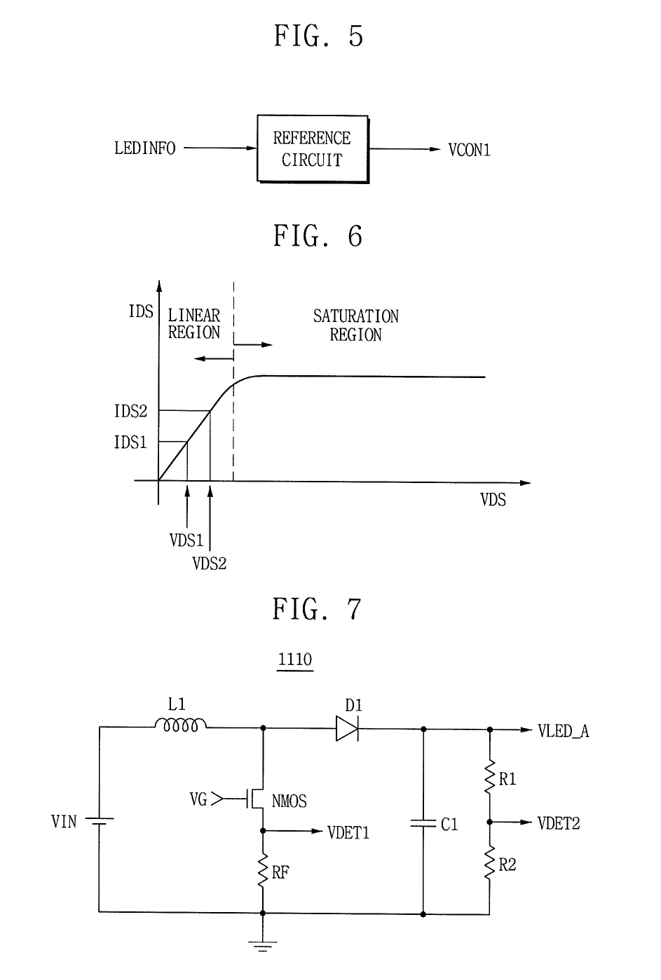

FIG. 5 illustrates a block diagram of an exemplary embodiment of a circuit for generating the control signal (VCON1) employable in the LED system 1000 of FIG. 1. Referring to FIG. 5, the first control signal VCON1 may be generated by a reference circuit based on an LED current information signal LEDINFO.

FIG. 6 illustrates a graph of a relationship between a drain-source voltage VDS and a drain current IDS of an NMOS transistor, e.g., 1163, of the current driver, e.g., 1160, of FIG. 3.

Referring to FIG. 6, in a linear region in which the drain-source voltage VDS is low, the drain current IDS increases as the drain-source voltage VDS increases, and, in a saturation region in which the drain-source voltage VDS is relatively high, the drain current IDS maintains a constant value even if the drain-source voltage VDS increases. In the linear region, when the drain-source voltage VDS is very low, the NMOS transistor 1163 operates in a triode region in which the drain current IDS is directly proportional to the drain-source voltage VDS. In the triode region, the NMOS transistor 1163 functions as a resistor.

For example, when the current driver 1160 has a specification that the resistance of the resistor RS is 5Ω and a drain current of the NMOS transistor 1163 is 40 mA, a voltage across the resistor RS is 200 mV. When a drain voltage of the NMOS transistor 1163, that is, the voltage signal VLED_K1 of the first terminal L_K1 of the LED string 1510, is 500 mV, a voltage of 300 mV is dropped between a drain and a source of the NMOS transistor 1163. In the VDS-IDS curve of FIG. 6, when VDS2 is 300 mV and IDS is 40 mA, if the drain voltage of the NMOS transistor 1163, that is, the voltage signal VLED_K1 of the first terminal L_K1 of the LED string 1510, changes from 500 mV (VDS2) to 400 mV (VDS1), a current of 40 mA may not flow through the NMOS transistor 1163.

The LED driving circuit 1100 shown in FIG. 1 may change the drain-source voltage from VDS1 to VDS2 when a drain current of the NMOS transistor 1163 changes from IDS1 to IDS2. Therefore, the LED driving circuit 1100 shown in FIG. 1 may operate following the characteristic curve of the NMOS transistor 1163 shown in FIG. 6 without increasing a size of the NMOS transistor 1163. Therefore, in one or more embodiments, the size of the NMOS transistor 1163 may not be increased even if a target LED current input from the exterior is increased.

Further, in one or more embodiments, the LED driving circuit 1100 may maintain the LED driving voltage VLED_A higher than the LED driving voltage of a conventional LED driving circuit even when the LED driving voltage VLED_A decreases because the current-driving-circuit enabling signal CD_EN is enabled by the LED driving circuit 1100. Therefore, the drain-source voltage VDS of the power transistor, e.g. the NMOS transistor 1163, in the LED driving circuit 1100 may be maintained higher than the voltage of a conventional LED driving circuit. Accordingly, the LED system 1000 including the LED driving circuit 1100 may have a high operating speed.

FIG. 7 illustrates a circuit diagram of an exemplary embodiment of the power supply circuit 1110 employable in the LED driving circuit 1100 of FIG. 2.

The power supply circuit 1110 may be a direct current (DC)-DC converter, e.g., a boost converter which receives a DC input voltage VIN and outputs a stable high DC voltage. Referring to FIG. 7, the power supply circuit 1110 may include an inductor L1, a first resistor RF, an n-channel metal-oxide semiconductor (NMOS) power transistor NMOS, a diode D1, a capacitor C1, a second resistor R1 and a third resistor R2.

Hereinafter, exemplary operation of the power supply circuit 1110 of FIG. 7 will be described.

First, during an active period of a gate control signal VG, in which the gate control signal VG is in a logic high state, the NMOS power transistor NMOS is turned on and a current flows through the inductor L1, the NMOS power transistor NMOS and the first resistor RF. In this condition, the inductor L1 may convert electric energy into magnetic energy corresponding to the current and may store the magnetic energy. Therefore, the longer the active period of the gate control signal VG, the more magnetic energy may be stored in the inductor L1.

Next, during an inactive period of the gate control signal VG, in which the gate control signal VG is in a logic low state, the NMOS power transistor NMOS is turned off, and the magnetic energy stored in the inductor L1 during the active period of the gate control signal VG may be converted into electric energy. That is, the inductor L1 may generate a current by an electromotive force dependent on a magnitude of the stored magnetic energy, and the current may flow through the diode D1, the second resistor R1, and the third resistor R2. The magnetic energy stored in the inductor L1 may decrease at the same speed as the increase of the magnetic energy. Meanwhile, the LED driving voltage VLED_A is generated at the output node, e.g., at one end of the second resistor R1, as a result of the electromotive force of the inductor L1 and the input voltage VIN. Further, the LED driving voltage VLED_A may be charged in the capacitor C1 connected in parallel with the resistors R1 and R2. If the magnetic energy stored in the inductor L1 during the active period of the gate control signal VG is large, the electromotive force of the inductor L1 is large, and therefore the LED driving voltage VLED_A may be further boosted.

Next, when the gate control signal VG is activated again, current flows through the NMOS power transistor NMOS and the first resistor RF, and the magnetic energy is stored in the inductor L1 again. At this time, the voltage level of the LED driving voltage VLED_A is maintained by the voltage stored in the capacitor C1.

As described above, the power supply circuit 1110 increases the electromotive force of the inductor L1 to increase the LED driving voltage VLED_A when a duty ratio of the gate control signal VG increases, and decreases the electromotive force of the inductor L1 to decrease the LED driving voltage VLED_A when the duty ratio of the gate control signal VG decreases.

As shown in FIG. 7, the duty ratio of the gate control signal VG may be changed based on a first detection voltage VDET1 corresponding to the current flowing through the NMOS power transistor NMOS and a second detection voltage VDET2 that is a sensed voltage of the LED driving voltage VLED_A.

In one or more embodiments, when the LED driving voltage VLED_A is lower than a target voltage, the power supply circuit 1110 increases the duty ratio of the gate control signal VG to boost the LED driving voltage VLED_A by increasing the electromotive force of the inductor L1. On the other hand, when the LED driving voltage VLED_A is higher than the target voltage, the power supply circuit 1110 decreases the duty ratio of the gate control signal VG to lower the LED driving voltage VLED_A by decreasing the electromotive force of the inductor L1.

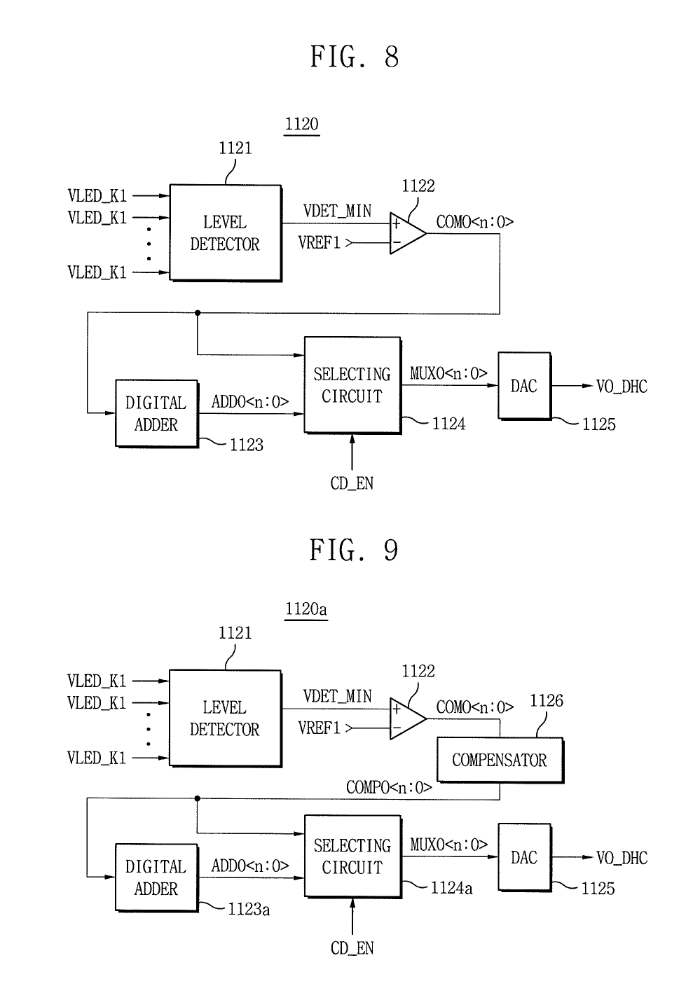

FIG. 8 illustrates a circuit diagram of an exemplary embodiment of a dynamic headroom controller 1120 employable in the LED driving circuit 1100 of FIG. 2.

Referring to FIG. 8, the dynamic headroom controller 1120 may include a level detector 1121, a comparator 1122, an adder 1123, a selecting circuit 1124, and a digital-to-analog converter 1125.

Referring to FIGS. 1 and 8, the level detector 1121 may detect voltage levels of the voltage signals VLED_K1, VLED_K2, . . . , VLED_Kn of the first terminals L_K1, L_K2, . . . , L_Kn of each of the LED strings 1510, 1520, 1530. The level detector 1121 may generate a minimum detection voltage signal VDET_MIN having a minimum voltage level of the detected voltage levels. The comparator 1122 may compare the minimum detection voltage signal VDET_MIN with a first reference voltage VREF1 to generate comparison output data COMO<n:0>. The adder 1123 may be a digital adder, and may add first data to the comparison output data COMO<n:0> to generate added output data ADDO<n:0>. The selecting circuit 1124 may select one of the comparison output data COMO<n:0> and the added output data ADDO<n:0> in response to the current-driving-circuit enabling signal CD_EN. The digital-to-analog converter 1125 may perform digital-to-analog conversion with respect to an output signal of the selecting circuit MUXO<n:0> to generate the dynamic headroom control signal VO_DHC.

FIG. 9 illustrates a circuit diagram of another exemplary embodiment of a dynamic headroom controller 1120a employable in the LED driving circuit 1100 of FIG. 2. In general, only differences between the exemplary dynamic headroom controller 1120a of FIG. 9 and the exemplary dynamic headroom controller 1120 of FIG. 8 will be described below.

Referring to FIG. 9, the dynamic headroom controller 1120a may include the level detector 1121, the comparator 1122, a compensator 1126, an adder 1123a, a selecting circuit 1124a, and the digital-to-analog converter 1125.

The compensator 1126 may compensate for a frequency characteristic of the comparison output data COMO<n:0> that is output data of the comparator 1122. The adder 1123a and the selecting circuit 1124a may substantially correspond to the adder 1123 and the selecting circuit 1124 of FIG. 8, but employ the frequency compensated comparison output data COMPO<n:0> from the compensator 1126.

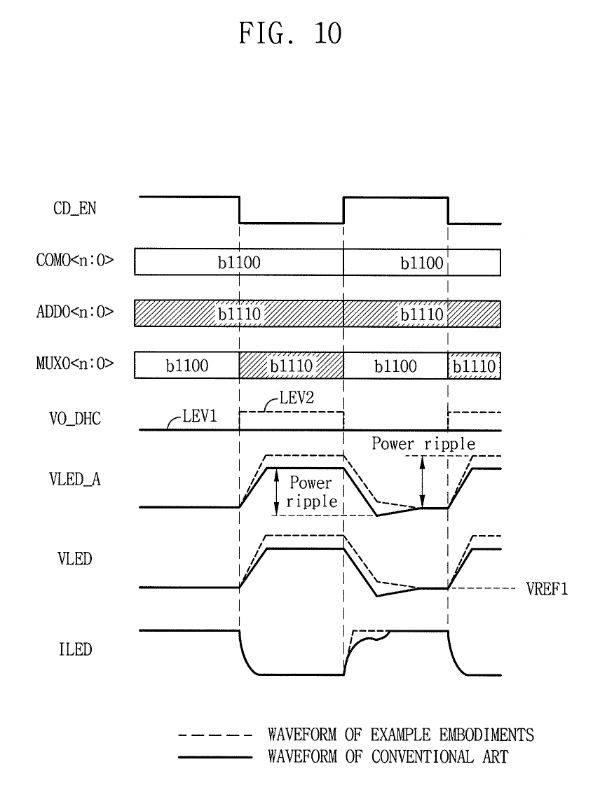

FIG. 10 illustrates a timing diagram of exemplary operations of the LED system of FIG. 1. The symbols of signals are the same as the symbols in the LED system described above with reference to FIGS. 1 to 9. In FIG. 10, the dotted lines illustrate operations of LED systems in accordance with exemplary embodiments, and the solid lines illustrate operations of conventional LED systems. Further, VLED shown in FIG. 10 denotes one of the voltage signals VLED_K1, VLED_K2, . . . , VLED_Kn of the first terminals of each of the LED strings, and ILED denotes currents flowing through the LED strings.

In the example of FIG. 10, the comparison output data COMO<n:0> may have a value of b1100, and the added output data ADDO<n:0> may have a value of b1100 that is the added value of the comparison output data COMO<n:0> and first data b0010. The selecting circuit 1124 may output the comparison output data COMO<n:0> when the current-driving-circuit enabling signal CD_EN is enabled, and may output the added output data ADDO<n:0> when the current-driving-circuit enabling signal CD_EN is disabled. That is, the selecting circuit 1124 may output b1100 when the current-driving-circuit enabling signal CD_EN is enabled, and may output b1110 when the current-driving-circuit enabling signal CD_EN is disabled.

The dynamic headroom control signal VO_DHC may have a first voltage level LEV1 when the current-driving-circuit enabling signal CD_EN is enabled, and may have a second voltage level LEV2 higher than the first voltage level LEV1 when the current-driving-circuit enabling signal CD_EN is disabled. The output signal VLED_A of the LED driving circuit 1100 may be larger than in a conventional art, and, also unlike the conventional art, may not include undershoots.

The dynamic headroom controller may increase magnitudes of the voltage signals of the first terminals of each of the LED strings when the current-driving-circuit enabling signal CD_EN is disabled, and may maintain the magnitudes of the voltage signals of the first terminals of each of the LED strings higher than a first reference voltage VREF1 corresponding to a voltage signal having a minimum voltage level among voltage signals of the first terminals of each of the LED strings when the current-driving-circuit enabling signal CD_EN is enabled. In one or more embodiments, the current ILED flowing through the LED strings may not be distorted when the current-driving-circuit enabling signal CD_EN changes from a disabled state to an enabled state, unlike the conventional art. That is, e.g. as shown in FIG. 10, the a current ILED flowing through the LED strings may increase linearly and/or substantially linearly before reaching a constant and/or substantially constant level when the current-driving-circuit enabling signal CD_EN changes from a disable state to an enable state.

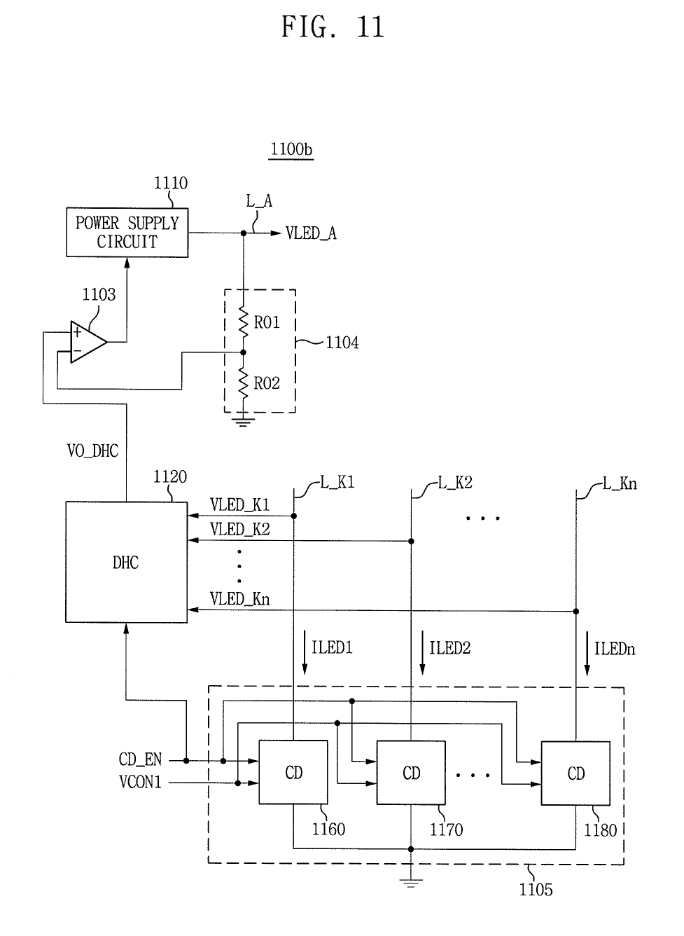

FIG. 11 illustrates a block diagram of another exemplary embodiment of an LED driving circuit 1100b employable in the LED system 1000 of FIG. 1. In general, only differences between the exemplary LED driving circuit 1100b of FIG. 11 and the exemplary LED driving circuit 1100 of FIG. 2 will be described below.

Referring to FIG. 11, compared to the LED driving circuit 1100 of FIG. 2, the LED driving circuit 1100b further includes a voltage divider 1104 and an error amplifier 1103. The voltage divider 1104 may include resistors R01 and R02.

The error amplifier 1103 may amplify a difference between a feedback voltage corresponding to the LED driving voltage VLED_A and the dynamic headroom control signal VO_DHC to generate a first amplified signal. The error amplifier 1103 may provides the first amplified signal to the power supply circuit 1110.

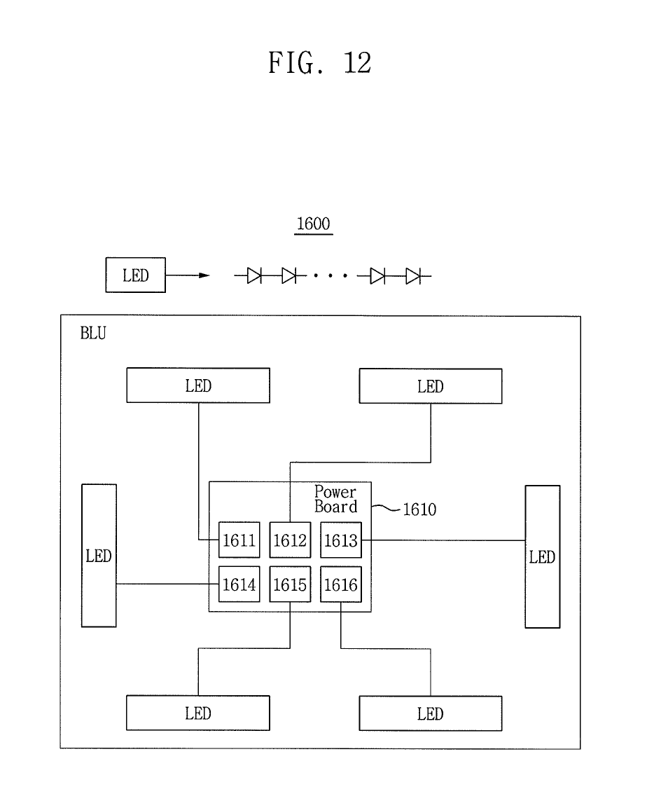

FIG. 12 illustrates a block diagram of an exemplary embodiment of a back-light system 1600 including an LED driving circuit, e.g., 1100, 1100a, 1100b, including one or more features described herein.

Referring to FIG. 12, the back-light system 1600 may include a back-light unit (BLU) BLU, a power board 1610 included in the BLU, and LED arrays LED. Each of the LED arrays LED may include at least one LED string. The LED string may include at least one LED. The power board 1610 may include a plurality of LED driving circuits 1611 to 1616. Each of the LED driving circuits 1611 to 1616 may have a structure including one or more features described above, e.g., the LED driving circuit 1100, 1100a, 1100b. Each of the LED driving circuits 1611 to 1616 may generate a dynamic headroom control signal VO_DHC having a voltage level that changes according to a logic state of a current-driving-circuit enabling signal CD_EN, and may generate the LED driving voltage VLED_A based on the dynamic headroom control signal VO_DHC.

In one or more embodiments, the back-light system 1600 including the LED driving circuits 1611 to 1616 may prevent distortion of LED current, and/or a current driving circuit included in the LED driving circuits 1611 to 1616 may have a high operating speed.

The back-light system 1600 shown in FIG. 12 may be applied, e.g., to display devices including large display panels such as edge-type LED television sets.

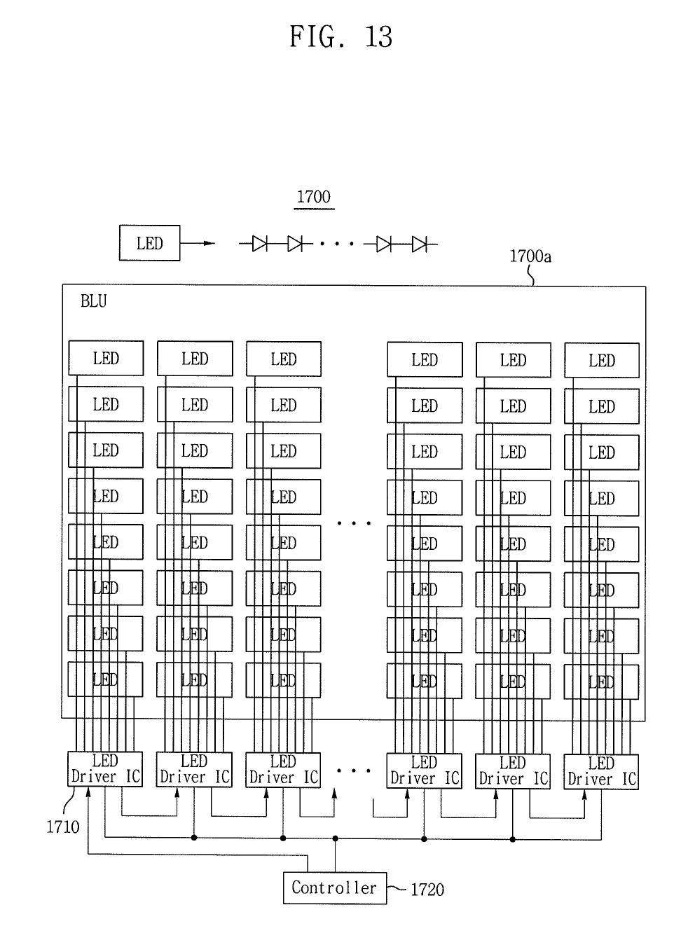

FIG. 13 illustrates a block diagram of another exemplary embodiment of a back-light system 1700 including an LED driving circuit.

Referring to FIG. 13, the back-light system 1700 may include a BLU including LED arrays LED, a controller 1720, and LED drivers 1710. The LED drivers 1710 may drive the LED arrays LED under the control of the controller 1720. Each of the LED arrays LED may include at least one LED string. The LED string may include at least one LED.

Each of the LED drivers 1710 may have a structure including one or more features described above, e.g., the LED driving circuit 1100, 1100a, 1100b. Each of the LED drivers 1710 may generate a dynamic headroom control signal VO_DHC having a voltage level that changes according to a logic state of a current-driving-circuit enabling signal CD_EN, and may generate the LED driving voltage VLED_A based on the dynamic headroom control signal VO_DHC.

In one or more embodiments, the back-light system 1700 including the LED driving circuits 1710 may prevent distortion of LED current, and/or a current driving circuit included in the LED driver circuits 1710 may have a high operating speed.

The back-light system 1700 shown in FIG. 13 may be applied to, e.g., display devices including large display panels such as direct-type LED television sets.

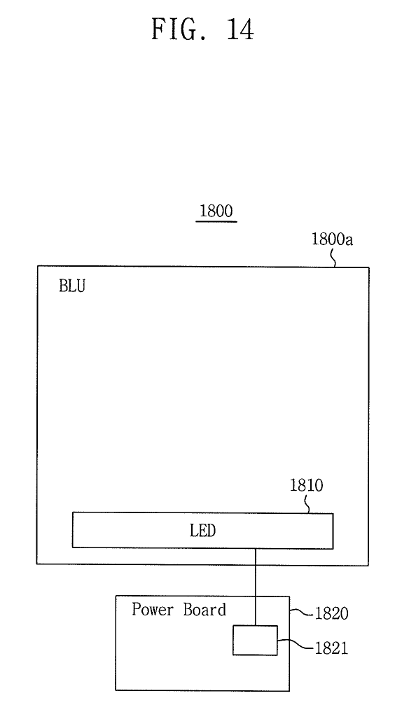

FIG. 14 illustrates a block diagram of another exemplary embodiment of a back-light system including an LED driving circuit.

Referring to FIG. 14, a back-light system 1800 may include a BLU 1800a including LED arrays LED and a power board 1820 that is outside of the BLU 1800a. Each of the LED arrays (LED) 1810 may include at least one LED string. The LED string may include at least one LED. The power board 1820 may include an LED driving circuit 1821 having a similar circuit structure to the LED driving circuit 1100 shown in FIG. 1. Each of the LED driving circuits 1821 may generate a dynamic headroom control signal having a voltage level that changes according to a logic state of a current-driving-circuit enabling signal CD_EN, and may generate the LED driving voltage VLED_A based on the dynamic headroom control signal.

In one or more embodiments, the back-light system 1800 including the LED driving circuits 1821 may prevent distortion of LED current, and a current driving circuit included in the LED driving circuits 1710 may have a high operating speed.

The back-light system 1800 shown in FIG. 14 may be applied to, e.g., display devices including small display panels such as a mobile phone, a personal digital assistant (PDA) and a portable multimedia player (PMP).

In the above, the back-light driving circuit mainly used in a liquid-crystal-display panel (LCD) is described, but the example embodiments may be applied to general display devices such as a plasma display panel (PDP), an organic light emitting diode (OLED), an LED for a lamp, etc.

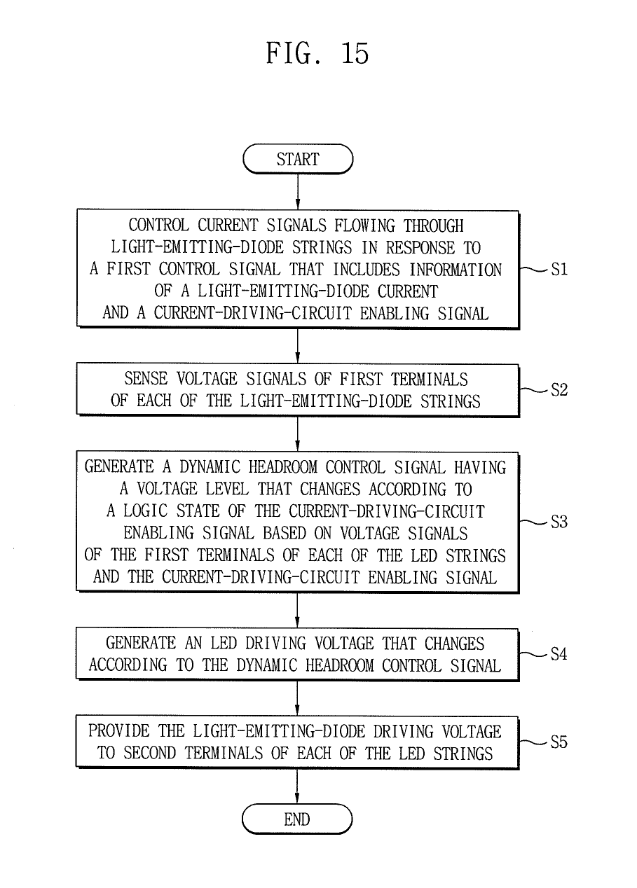

FIG. 15 illustrates a flowchart of an exemplary embodiment of a method of driving an LED.

Referring to FIG. 15, the method of driving an LED may include the following operations of:

1) controlling current signals flowing through LED strings in response to a first control signal that includes information of a LED current and a current-driving-circuit enabling signal (S1);

2) sensing voltage signals of first terminals of each of the LED strings (S2);

3) generating a dynamic headroom control signal having a voltage level that changes according to a logic state of the current-driving-circuit enabling signal based on voltage signals of the first terminals of each of the LED strings and the current-driving-circuit enabling signal (S3);

4) generating an LED driving voltage that changes according to the dynamic headroom control signal (S4); and

5) providing the LED driving voltage to second terminals of each of the LED strings (S5).

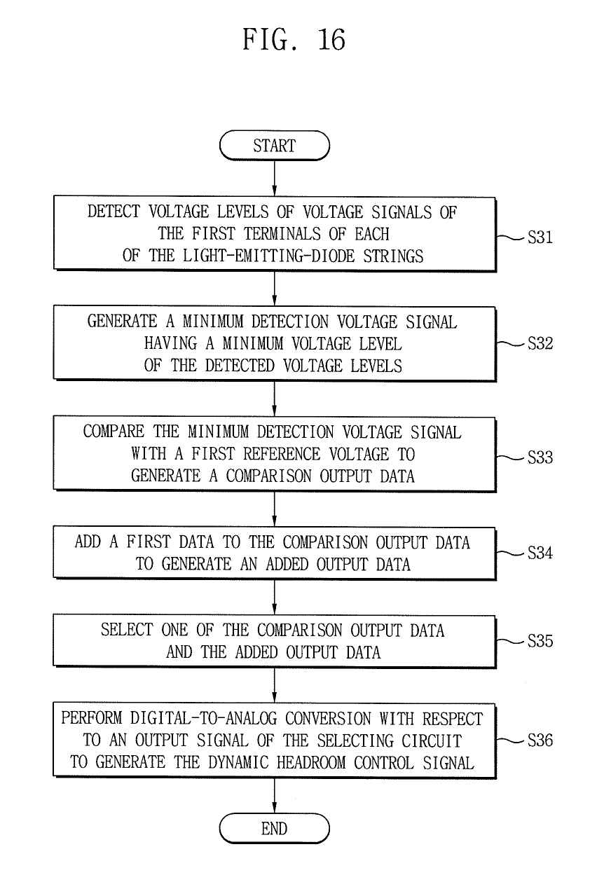

FIG. 16 illustrates a flowchart of an exemplary embodiment of a method of generating a dynamic headroom control signal (VO_DHC) shown in FIG. 15.

Referring to FIG. 16, the method of generating a dynamic headroom control signal (VO_DHC) may include the following operations of:

1) detecting voltage levels of voltage signals of the first terminals of each of the LED strings (S31);

2) generating a minimum detection voltage signal having a minimum voltage level of the detected voltage levels (S32);

3) comparing the minimum detection voltage signal with a first reference voltage to generate comparison output data (S33);

4) adding first data to the comparison output data to generate added output data (S34);

5) selecting one of the comparison output data and the added output data in response to the current-driving-circuit enabling signal (S35); and

6) performing digital-to-analog conversion with respect to an output signal of the selecting circuit to generate the dynamic headroom control signal (S36).

As described above, one or more embodiments of the LED driving circuit including one or more features described herein, e.g., 1100, 1100a, 1100b, may include a dynamic headroom controller that generates a dynamic headroom control signal having a voltage level that changes according to a logic state of the current-driving-circuit enabling signal. The LED driving circuit including one or more features described herein, e.g., 1100, 1100a, 1100b, may generate an LED driving voltage VLED_A based on the dynamic headroom control signal. The LED system including the LED driving circuit 1100 may maintain the voltage of a node of LED strings connected to a current driving circuit higher than a certain value so that the current driving circuit that controls a current flowing through the LED strings may operate even when a ripple is included in the LED driving voltage VLED_A. Therefore, one or more embodiments of the LED system 1000 including the LED driving circuit employing one or more features described herein, e.g., 1100, 1100a, 1100b, may prevent distortion of LED current. Further, the LED system 1000 including the LED driving circuit 1100 may maintain a drain-source voltage of each power transistor included in the LED driving circuit 1100 higher than the voltage of a conventional LED system. One or more embodiments of an LED system including one or more features described herein, e.g., 1000, including the LED driving circuit including one or more features described herein, e.g., 1100, 1100a, 1100b, may have a high operating speed.

Embodiments of the inventive concept may be applied to display devices and lighting devices, particularly to a BLU of the display devices.

Various example embodiments are described herein with reference to the accompanying drawings in which some example embodiments are shown. In the drawings, sizes of regions may be exaggerated for clarity.

Detailed illustrative embodiments are disclosed herein. However, specific structural and functional details disclosed herein are merely representative for purposes of describing example embodiments.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. It will be understood that the spatially relative terms are intended to encompass different orientations of the device in use or operation in addition to the orientation depicted in the Figures.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A light-emitting-diode (LED) driving circuit, comprising:
a current driving circuit configured to control current signals flowing through LED strings in response to a first control signal that includes information of an LED current and a current-driving-circuit enabling signal;
a dynamic headroom controller configured to generate a dynamic headroom control signal having a voltage level that changes according to a logic state of the current-driving-circuit enabling signal based on voltage signals of first terminals of each of the LED strings and the current-driving-circuit enabling signal; and
a power supply circuit configured to generate an LED driving voltage that changes according to the dynamic headroom control signal and to provide the LED driving voltage to second terminals of each of the LED strings.

2. The LED driving circuit as claimed in claim 1, wherein the dynamic headroom control signal is configured to have a first voltage level when the current-driving-circuit enabling signal is enabled, and have a second voltage level higher than the first voltage level when the current-driving-circuit enabling signal is disabled.

3. The LED driving circuit as claimed in claim 1, wherein the dynamic headroom controller is configured to increase magnitudes of the voltage signals of the first terminals of each of the LED strings when the current-driving-circuit enabling signal is disabled and to maintain the magnitudes of the voltage signals of the first terminals of each of the LED strings higher than a first reference voltage corresponding to a voltage signal having a lowest voltage level among voltage signals of the first terminals of each of the LED strings when the current-driving-circuit enabling signal is enabled.

4. The LED driving circuit as claimed in claim 3, wherein a current flowing through each of the LED strings is not distorted when the current-driving-circuit enabling signal changes from a disable state to an enable state.

5. The LED driving circuit as claimed in claim 3, wherein a current flowing through each of the LED strings increases linearly and/or substantially linearly before reaching a constant and/or substantially constant level when the current-driving-circuit enabling signal changes from a disable state to an enable state.

6. The LED driving circuit as claimed in claim 1, wherein the dynamic headroom controller includes:
a level detector configured to detect voltage levels of voltage signals of the first terminals of each of the LED strings, and generate a minimum detection voltage signal having a minimum voltage level of the detected voltage levels;
a comparator configured to compare the minimum detection voltage signal with a first reference voltage to generate comparison output data;
an adder configured to add first data to the comparison output data to generate added output data;
a selecting circuit configured to select one of the comparison output data and the added output data in response to the current-driving-circuit enabling signal; and
a digital-to-analog converter configured to perform digital-to-analog conversion with respect to an output signal of the selecting circuit to generate the dynamic headroom control signal.

7. The LED driving circuit as claimed in claim 6, wherein the selecting circuit is configured to output the comparison output data when the current-driving-circuit enabling signal is enabled and to output the added output data when the current-driving-circuit enabling signal is disabled.

8. The LED driving circuit of claim 1, wherein the dynamic headroom controller includes:
a level detector configured to detect voltage levels of voltage signals of the first terminals of each of the LED strings and to generate a minimum detection voltage signal having a minimum voltage level of the detected voltage levels;
a comparator configured to compare the minimum detection voltage signal with a first reference voltage to generate comparison output data;
a compensating circuit configured to compensate a frequency characteristic of the comparison output data;
an adder configured to add first data to output data of the compensating circuit to generate added output data;
a selecting circuit configured to select one of the comparison output data and the added output data in response to the current-driving-circuit enabling signal; and
a digital-to-analog converter configured to perform digital-to-analog conversion with respect to an output signal of the selecting circuit to generate the dynamic headroom control signal.

9. The LED driving circuit as claimed in claim 1, wherein a voltage between a source and a drain of a power transistor included in the current driving circuit changes according to a change of current signals flowing through the LED strings.

10. The LED driving circuit as claimed in claim 1, further comprising:
an error amplifier configured to amplify a difference between a feedback voltage corresponding to the LED driving voltage and the dynamic headroom control signal to generate a first amplified signal and to provide the first amplified signal to the power supply circuit.

11. The LED driving circuit as claimed in claim 1, wherein each of the LED strings includes at least one LED serially connected to each other.

12. The LED driving circuit as claimed in claim 1, wherein second terminals of each of the LED strings are electrically connected to each other.

13. The LED driving circuit as claimed in claim 1, wherein the power supply circuit is a DC-DC converter.

14. The LED driving circuit as claimed in claim 1, wherein the power supply circuit includes an inductor, first, second, and third resistors, an NMOS power transistor, a diode, and a capacitor.

15. The LED driving circuit as claimed in claim 1, wherein the current driving circuit includes a plurality of current drivers, each including an amplifier, a switch, an NMOS transistor, and a resistor.

16. The LED driving circuit as claimed in claim 15, wherein the switch is configured to operate in response to the current-driving-circuit enabling signal, a first terminal to which the first control signal is applied and a second terminal coupled to a gate of the NMOS transistor.

17. A method of driving a light-emitting diode (LED), the method comprising:
controlling current signals flowing through LED strings in response to a first control signal that includes information of an LED current and a current-driving-circuit enabling signal;
sensing voltage signals of first terminals of each of the LED strings;
generating a dynamic headroom control signal having a voltage level that changes according to a logic state of the current-driving-circuit enabling signal based on voltage signals of the first terminals of each of the LED strings and the current-driving-circuit enabling signal;
generating an LED driving voltage that changes according to the dynamic headroom control signal; and
providing the LED driving voltage to second terminals of each of the LED strings.

18. The method as claimed in claim 17, wherein the dynamic headroom control signal is configured to have a first voltage level when the current-driving-circuit enabling signal is enabled, and have a second voltage level higher than the first voltage level when the current-driving-circuit enabling signal is disabled.

19. The method as claimed in claim 17, wherein generating the dynamic headroom control signal includes:
detecting voltage levels of voltage signals of the first terminals of each of the LED strings;
generating a minimum detection voltage signal having a minimum voltage level of the detected voltage levels;
comparing the minimum detection voltage signal with a first reference voltage to generate comparison output data;
adding first data to the comparison output data to generate added output data;
selecting one of the comparison output data and the added output data in response to the current-driving-circuit enabling signal; and
performing digital-to-analog conversion with respect to an output signal of the selecting circuit to generate the dynamic headroom control signal.

20. The method as claimed in claim 19, further comprising:
compensating for a frequency characteristic of the comparison output data.

21. A light-emitting-diode (LED) driving circuit including an LED string, the circuit comprising:
a selecting circuit configured to output one of a first voltage and a second voltage that is different from the first voltage based on a logical state of a current-driving-circuit enabling signal, wherein the first or second voltage output from the selecting circuit is employed to generate a control signal to be supplied to the LED string.
